(19) United States
(12) Patent Application Publication
(10) Pub. No.: US 2010/0149414 A1
(43) Pub. Date: Jun. 17, 2010

(54) Method and Apparatus for Processing Video

(75) Inventors: Kuo-Hua Chen, Hsichih (TW); Yu-Che Tsai, Hsichih (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WISTRON CORP., Hsichih, Taipei Hsien (TW)

(21) Appl. No.: 12/501,682

(22) Filed: Jul. 13, 2009

(30) Foreign Application Priority Data
Dec. 17, 2008 (TW) 97149225

(51) Int. Cl. H04N 7/01

(52) U.S. Cl. 348/447; 348/E07.003

(57) ABSTRACT

In the specification and drawing a method for processing video is disclosed. The method comprises the following steps: at least one frame rate of the video is detected, and a refresh rate of a display is adjusted to about 96 Hz when the frame rate is about 24 fps. Moreover, an apparatus for processing video is also disclosed in the specification and drawing.

### RELATED APPLICATIONS

This application claims priority to Taiwan Application Serial Number 97149225, filed Dec. 17, 2008, which is herein incorporated by reference.

### BACKGROUND

1. Field of Invention

The present invention relates to a control method, system and equipment. More particularly, the present invention relates to an apparatus and a method for processing video.

2. Description of Related Art

With the fast development of the digital information and multimedia applications, as well as display manufacturers develop the markets, the application of displays has become more popular. For example, flat-panel displays are commonly used devices in homes and offices. People look forward to high-quality video displays.

In order to display a smooth video, the refresh rate of the display is always set for 120 Hz to reduce response time. In this manner, however, the display shows video with judder, halo and so forth when the frame rate of the video is 24 fps.

In view of above, there is a need in the related field to provide a method and/or an apparatus for processing video, whereby the display shows smooth video without judder, halo and so forth.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more aspects, the present disclosure is directed to an apparatus and a method for processing video.

In accordance with an embodiment of the present disclosure, the method for processing video comprises the following steps: at least one frame rate of the video is detected, and a refresh rate of a display is adjusted to about 96 Hz when the frame rate is about 24 fps.

In accordance with another embodiment of the present disclosure, the apparatus for processing video comprises a detection unit and a first control unit. The detection unit can detect at least one frame rate of the video; the first control unit can adjust a refresh rate of a display to about 96 Hz when the frame rate is about 24 fps.

Accordingly, the refresh rate of the display is increased to reduce response time; therefore, the display can show smooth video without judder, halo and so forth.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 shows a flow chart of a method 100 for processing video according to an embodiment of the present disclosure;

FIG. 2 is a schematic diagram of processing video in accordance with one or more aspects of the present disclosure;

FIG. 3 shows a flow chart of a method 300 for processing video according to another embodiment of the present disclosure; and

FIG. 4 shows a block diagram of an apparatus for processing video according to another embodiment of the present disclosure.

Like reference numerals are used to designate like parts in the accompanying drawings.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

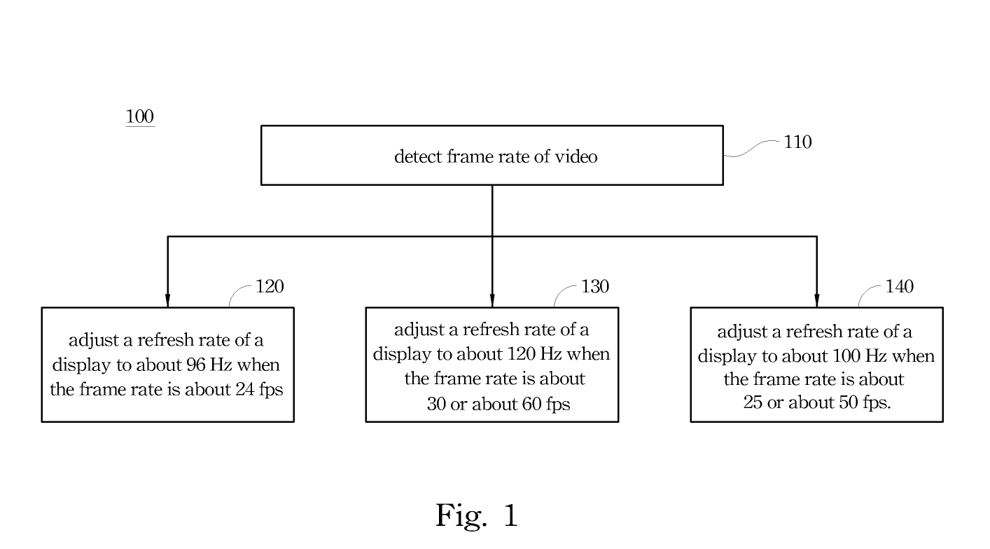

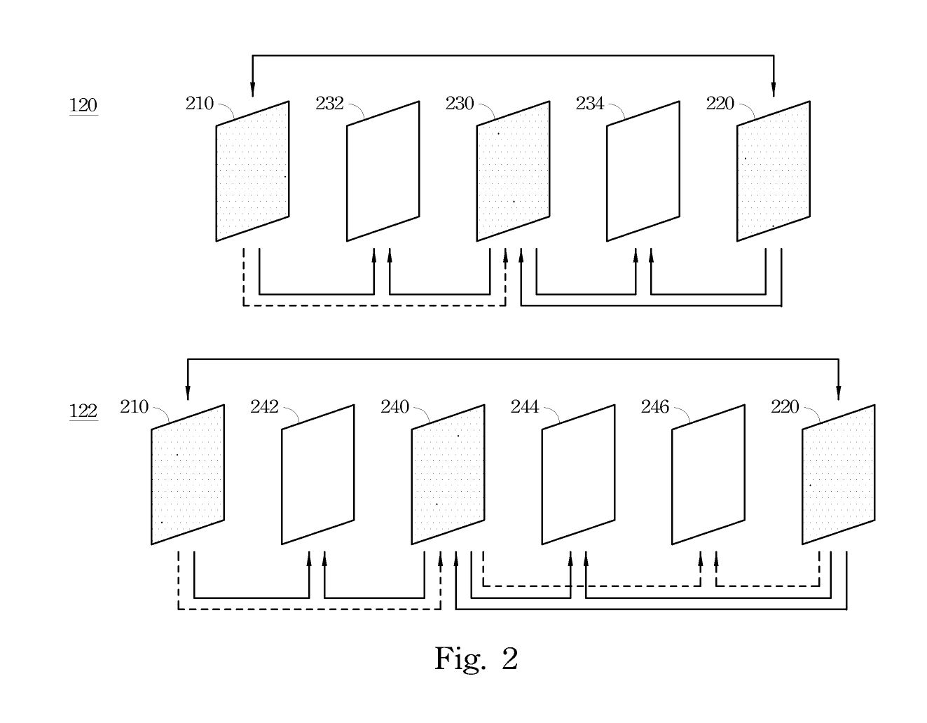

One aspect of the present disclosure is directed to a method for processing video. The method may be easily inserted into display and may be applicable or readily adaptable to all technology nodes. It should be noted that users could watch smooth video as the refresh rate of the display is above 90 Hz according to experiments. Herewith the method for processing video is illustrated by reference to the following description considered in FIG. 1 and FIG. 2.

Please refer to FIG. 1. FIG. 1 shows a flow chart of a method 100 for processing video according to an embodiment of the present disclosure. The method 100 at least comprises step 110 and step 120. In the method 100, it should be noted that one step might be performed in series, in parallel, in combination, or otherwise in conjunction with another if the specific order is not described or inferred in the embodiment.

In step 110, at least one frame rate of the video is detected; in step 120, a refresh rate of a display is adjusted to about 96 Hz when the frame rate is about 24 fps. Accordingly, the refresh rate of the display is increased to reduce response time; therefore, the display can show smooth video without judder, halo and so forth.

The video comprises a plurality of frames; for example, the video may be a video signal or the like. The display may be an LCD or the like.

During step 110, the mode of the video is determined by detecting the frame rate of the video. The video belongs to Film mode when the frame rate of the video is about 24 fps. The video belongs to Video mode when the frame rate of the video is about 30 fps or about 60 fps; similarly, the video belongs to Video mode when the frame rate of the video is about 25 fps or about 50 fps.

The video is filmed by film referred to as Film mode. The video is took by a video camera referred to as Video mode; for example, the frame rate of the video is about 25 fps or about 50 fps for PAL and SECAM television, and the frame rate of the video is about 30 fps or about 60 fps for NTSC television.

In step 120, as the frame rate of the video is about 24 fps, that is to say the video shows 24 frames per second; therefore, three interpolated frames are inserted between each two continuous frames of the video by means of interpolation technique, such as motion estimation & motion compensation. Thus, the refresh rate of the display is adjusted to about 96 (24×4) Hz.

During step 120, the refresh rate of the display is set for about 96 Hz when the frame rate of the video is changed to about 24 fps, and the refresh rate of the display is updated to about 96 Hz during a blanking interval after the refresh rate is set.

Furthermore, the refresh rate of the display is set for about 96 Hz when the frame rate of the video is changed from X fps to about 24 fps, wherein X fps is not about 24 fps.

In order to avoid affecting viewing of users when the refresh rate of the display is updated, the refresh rate of the display is updated to about 96 Hz during the blanking interval, whereby the users cannot perceive that the refresh rate is updated. Accordingly, the refresh rate of the display is maintained at about 96 Hz when the frame rate of the video is about 24 fps. In addition, the blanking interval may be a vertical blanking interval or a horizontal blanking interval.

In FIG. 1, the video processing method 100 comprises step 130. In step 130, the refresh rate of the display is adjusted to about 120 Hz when the frame rate is about 30 fps or about 60 fps. Accordingly, the refresh rate of the display is increased to reduce response time; therefore, the display can show smooth video without judder, halo and so forth.

In step 130, as the frame rate of the video is about 30 fps, that is to say the video shows 30 frames per second; therefore, three interpolated frames are inserted between each two continuous frames of the video by means of interpolation technique, such as motion estimation & motion compensation. Thus, the refresh rate of the display is adjusted to about 120 (30×4) Hz.

Alternatively, as the frame rate of the video is about 60 fps, that is to say the video shows 60 frames per second; therefore, one interpolated frame is inserted between each two continuous frames of the video by means of interpolation technique, such as motion estimation & motion compensation. Thus, the refresh rate of the display is adjusted to about 120 (60×2) Hz.

During step 130, the refresh rate of the display is set for about 120 Hz when the frame rate of the video is changed to about 30 fps or about 60 fps, and the refresh rate of the display is updated to about 120 Hz during a blanking interval after the refresh rate is set.

Furthermore, the refresh rate of the display is set for about 120 Hz when the frame rate of the video is changed from X fps to about 30 fps or about 60 fps, wherein X fps is not about 30 fps or about 60 fps.

In order to avoid affecting viewing of users when the refresh rate of the display is updated, the refresh rate of the display is updated to about 120 Hz during the blanking interval, whereby the users cannot perceive that the refresh rate is updated. Accordingly, the refresh rate of the display is maintained at about 120 Hz when the frame rate of the video is about 30 fps or about 60 fps. In addition, the blanking interval may be a vertical blanking interval or a horizontal blanking interval.

In FIG. 1, the video processing method 100 comprises step 140. In step 140, the refresh rate of the display is adjusted to about 100 Hz when the frame rate is about 25 fps or about 50 fps. Accordingly, the refresh rate of the display is increased to reduce response time; therefore, the display can show smooth video without judder, halo and so forth.

In step 140, as the frame rate of the video is about 25 fps, that is to say the video shows 25 frames per second; therefore, three interpolated frames are inserted between each two continuous frames of the video by means of interpolation technique, such as motion estimation & motion compensation. Thus, the refresh rate of the display is adjusted to about 100 (25×4) Hz.

Alternatively, as the frame rate of the video is about 50 fps, that is to say the video shows 50 frames per second; therefore, one interpolated frame is inserted between each two continuous frames of the video by means of interpolation technique, such as motion estimation & motion compensation. Thus, the refresh rate of the display is adjusted to about 100 (50×2) Hz.

During step 140, the refresh rate of the display is set for about 100 Hz when the frame rate of the video is changed to about 25 fps or about 50 fps, and the refresh rate of the display is updated to about 100 Hz during a blanking interval after the refresh rate is set.

Furthermore, the refresh rate of the display is set for about 100 Hz when the frame rate of the video is changed from X fps to about 25 fps or about 50 fps, wherein X fps is not about 25 fps or about 50 fps.

In order to avoid affecting viewing of users when the refresh rate of the display is updated, the refresh rate of the display is updated to about 100 Hz during the blanking interval, whereby the users cannot perceive that the refresh rate is updated. Accordingly, the refresh rate of the display is maintained at about 100 Hz when the frame rate of the video is about 25 fps or about 50 fps. In addition, the blanking interval may be a vertical blanking interval or a horizontal blanking interval.

The video processing method 100 may be executed in an image processor or a control chip, or be applied in programmed image control of the display. One of ordinary skill in the art will appreciate that the above examples are provided for illustrative purposes only to further explain applications of the present invention and are not meant to limit the present invention in any manner.

For a more complete understanding of step 120, please refer to FIG. 2. FIG. 2 is a schematic diagram of processing video in accordance with one or more aspects of the present disclosure. In step 120, one interpolated frame 230 is generated and inserted between two continuous frames 210,220 according to the continuous frames 210,220 by means of interpolation technique, such as motion estimation & motion compensation. Then, another interpolated frame 232 is generated and inserted between the frame 210 and the interpolated frame 230 according to the frame 210 and the interpolated frame 230 by means of interpolation technique, such as motion estimation & motion compensation. Similarly, yet another interpolated frame 234 is generated and inserted between the frame 220 and the interpolated frame 230 according to the frame 220 and the interpolated frame 230 by means of interpolation technique, such as motion estimation & motion compensation. In other words, three interpolated frames 230,232,234 are inserted between two continuous frames 210,220, whereby the refresh rate of the display is adjusted to about 96 (24×4) Hz. Moreover, only three interpolated frames 230,232,234 are needed to avoid an inaccurate interpolated frame generated because of complicated calculation, whereby the display can show smooth video without judder, halo and so forth.

In compared step 122, one interpolated frame 240 is generated and inserted between two continuous frames 210,220 according to the continuous frames 210,220 by means of interpolation technique. Then, another interpolated frame 242 is generated and inserted between the frame 210 and the interpolated frame 240 according to the frame 210 and the interpolated frame 240. Similarly, yet another two interpolated frame 244,246 are generated and inserted between the frame 220 and the interpolated frame 230 according to the frame 220 and the interpolated frame 230. Two or more interpolated frames are generated according to two continuous original frames of video, easily lead to inaccurate content of these interpolated frames. In other words, three interpolated frames 240,242,244,246 are inserted between two continuous frames 210,220, whereby the refresh rate of the display is adjusted to about 120 (24×5) Hz; however, at least four interpolated frames 240,242,244,246 are needed, so that one or more inaccurate interpolated frames of the interpolated frames 240,242,244,246 are generated because of complicated calculation, whereby the display may show video with judder, halo and so forth.

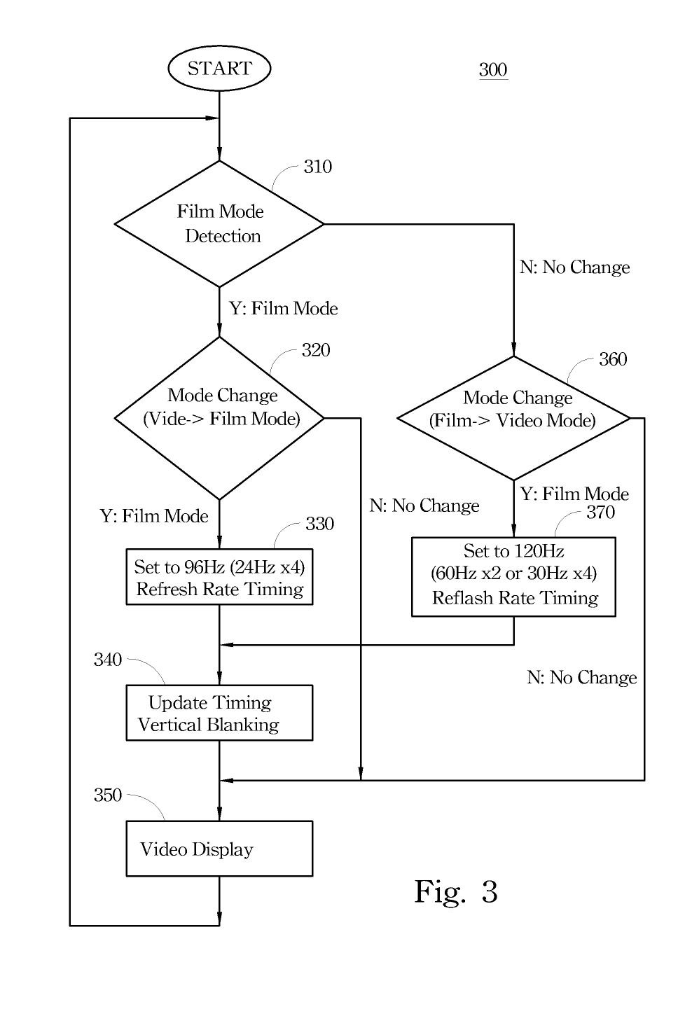

Please refer to FIG. 3. FIG. 3 shows a flow chart of a method 300 for processing video according to another embodiment of the present disclosure. The method 300 at least comprises step 310, step 320, step 330, step 340 and step 350. In the method 300, it should be noted that one step might be performed in series, in parallel, in combination, or otherwise in conjunction with another if the specific order is not described or inferred in the embodiment.

In step 310, whether the mode of video is Film mode or Video mode is detected; in step 320, whether the mode of the video is changed from Video mode to Film mode is determined when the mode of video is Film mode; in step 330, a refresh rate of a display is set for about 96 Hz when the mode of the video is changed from Video mode to Film mode; in step 340, the refresh rate of the display is updated to about 96 Hz during a blanking interval after the refresh rate is set; in step 350, the video is displayed by the display in accordance with the refresh rate is about 96 Hz when the mode of the video is Film mode.

The mode of the video is always Film mode is determined during step 320; therefore, the video is still displayed by the display in accordance with the refresh rate is about 96 Hz in step 350.

The method 300 further comprises step 360 and step 370. In step 360, whether the mode of the video is changed from Film mode to Video mode is determined when the mode of the video is Video mode; in step 370, the refresh rate of the display is set for about 120 Hz or about 100 Hz when the mode of the video is changed from Film mode to Video mode. In addition, the refresh rate of the display is updated to about 120 Hz or about 100 Hz during the blanking interval in step 340 after the refresh rate is set for about 120 Hz or about 100 Hz.

The mode of the video is always Video mode is determined during step 360; therefore, the video is still displayed by the display in accordance with the refresh rate is about 120 Hz or about 100 Hz in step 350.

In Film mode, the refresh rate of the display is adjusted to about 96 Hz when the frame rate of the video is about 24 fps. In Video mode, the refresh rate of the display is adjusted to about 120 Hz when the frame rate of the video is about 30 fps or about 60 fps; similarly, the refresh rate of the display is adjusted to about 100 Hz when the frame rate of the video is about 25 fps or about 50 fps.

Accordingly, the refresh rate of the display is increased to reduce response time; therefore, the display can show smooth video without judder, halo and so forth. Moreover, the refresh rate of the display is updated during the blanking interval in step 340, whereby the users cannot perceive that the refresh rate is updated.

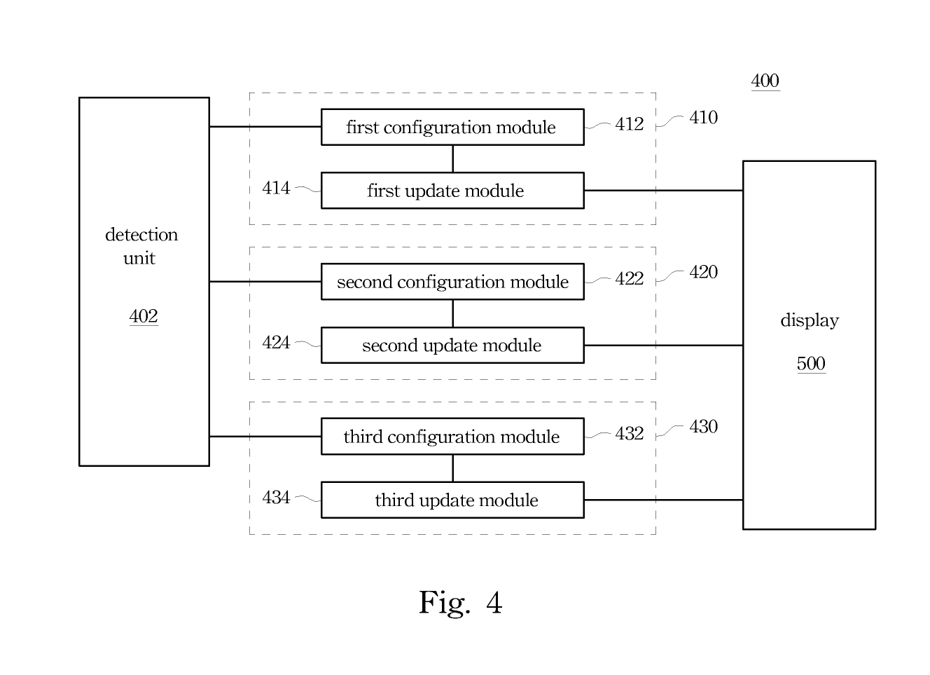

Another aspect of the present disclosure is directed to an apparatus for processing video. The apparatus may be easily integrated into display and may be applicable or readily adaptable to all technology nodes. It should be noted that users could watch smooth video as the refresh rate of the display is above 90 Hz according to experiments. Herewith the apparatus for processing video is illustrated by reference to the following description considered in FIG. 4.

Please refer to FIG. 4. FIG. 4 shows a block diagram of an apparatus 400 for processing video according to another embodiment of the present disclosure. The apparatus 400 comprises a detection unit 402 and a first control unit 410. The detection unit 402 can detect at least one frame rate of the video; the first control unit 410 can adjust a refresh rate of a display 500 to about 96 Hz when the frame rate is about 24 fps. Accordingly, the apparatus 400 can increase the refresh rate of the display 500 to reduce response time; therefore, the display 500 can show smooth video without judder, halo and so forth.

The video comprises a plurality of frames; for example, the video may be a video signal or the like. The display 500 may be an LCD or the like.

The detection unit 402 can detect the frame rate of the video to determine the mode of the video. The video belongs to Film mode when the frame rate of the video is about 24 fps. The video belongs to Video mode when the frame rate of the video is about 30 fps or about 60 fps; similarly, the video belongs to Video mode when the frame rate of the video is about 25 fps or about 50 fps.

The video is filmed by film referred to as Film mode. The video is took by a video camera referred to as Video mode; for example, the frame rate of the video is about 25 fps or about 50 fps for PAL and SECAM television, and the frame rate of the video is about 30 fps or about 60 fps for NTSC television.

As the frame rate of the video is about 24 fps, that is to say the video shows 24 frames per second, the first control unit 410 can insert three interpolated frames between each two continuous frames of the video by means of interpolation technique, such as motion estimation & motion compensation. Thus, the refresh rate of the display 500 is adjusted to about 96 (24×4) Hz.

In FIG. 4, the first control unit 410 comprises a first configuration module 412 and a first update module 414. The first configuration module 412 can set the refresh rate for about 96 Hz when the frame rate is changed to about 24 fps; the first update module 414 can update the refresh rate of the display 500 to about 96 Hz during a blanking interval after the refresh rate is set.

Furthermore, the first configuration module 412 can set the refresh rate of the display 500 for about 96 Hz when the frame rate of the video is changed from X fps to about 24 fps, wherein X fps is not about 24 fps.

In order to avoid affecting viewing of users when the refresh rate of the display 500 is updated, the first update module 414 can update the refresh rate of the display 500 to about 96 Hz during the blanking interval, whereby the users cannot perceive that the refresh rate is updated. Accordingly, the refresh rate of the display 500 is maintained at about 96 Hz when the frame rate of the video is about 24 fps. In addition, the blanking interval may be a vertical blanking interval or a horizontal blanking interval.

In FIG. 4, the apparatus 400 further comprises a second control unit 420. The second control unit 420 can adjust the refresh rate of the display 500 to about 120 Hz when the frame rate of the video is about 30 or about 60 fps. Accordingly, the apparatus 400 can increase the refresh rate of the display 500 to reduce response time; therefore, the display 500 can show smooth video without judder, halo and so forth.

As the frame rate of the video is about 30, that is to say the video shows 30 frames per second, the second control unit 420 can insert three interpolated frames between each two continuous frames of the video by means of interpolation technique, such as motion estimation & motion compensation. Thus, the refresh rate of the display 500 is adjusted to about 120 (30×4) Hz.

Alternatively, as the frame rate of the video is about 60 fps, that is to say the video shows 60 frames per second, the second control unit 420 can insert one interpolated frame between each two continuous frames of the video by means of interpolation technique, such as motion estimation & motion compensation. Thus, the refresh rate of the display 500 is adjusted to about 120 (60×2) Hz.

In FIG. 4, the second control unit 420 comprises a second configuration module 422 and a second update module 424. The second configuration module 422 can set the refresh rate of the display 500 for about 120 Hz when the frame rate of the video is changed to about 30 or about 60 fps; the second update module 424 can update the refresh rate to about 120 Hz during a blanking interval after the refresh rate is set.

Furthermore, the second configuration module 422 can set the refresh rate of the display 500 for about 120 Hz when the frame rate of the video is changed from X fps to about 30 fps or about 60 fps, wherein X fps is not about 30 fps or about 60 fps.

In order to avoid affecting viewing of users when the refresh rate of the display is updated, the second update module 424 can update the refresh rate of the display 500 to about 120 Hz during the blanking interval, whereby the users cannot perceive that the refresh rate is updated. Accordingly, the refresh rate of the display is maintained at about 120 Hz when the frame rate of the video is about 30 fps or about 60 fps. In addition, the blanking interval may be a vertical blanking interval or a horizontal blanking interval.

In FIG. 4, the apparatus 400 further comprises a third control unit 430. The third control unit 430 can adjust the refresh rate of the display to about 100 Hz when the frame rate of the video is about 25 or about 50 fps. Accordingly, the apparatus 400 can increase the refresh rate of the display 500 to reduce response time; therefore, the display 500 can show smooth video without judder, halo and so forth.

As the frame rate of the video is about 25, that is to say the video shows 25 frames per second, the third control unit 430 can insert three interpolated frames between each two continuous frames of the video by means of interpolation technique, such as motion estimation & motion compensation. Thus, the refresh rate of the display 500 is adjusted to about 100 (25×4) Hz.

Alternatively, as the frame rate of the video is about 50 fps, that is to say the video shows 50 frames per second, the third control unit 430 can insert one interpolated frame between each two continuous frames of the video by means of interpolation technique, such as motion estimation & motion compensation. Thus, the refresh rate of the display 500 is adjusted to about 100 (50×2) Hz.

In FIG. 4, the third control unit 430 comprises a third configuration module 432 and a third update module 434. The third configuration module 432 can set the refresh rate of the display 500 for about 100 Hz when the frame rate of the video is changed to about 25 or about 50 fps; the third update module 434 can update the refresh rate to about 100 Hz during a blanking interval after the refresh rate is set.

Furthermore, the third configuration module 432 can set the refresh rate of the display 500 for about 100 Hz when the frame rate of the video is changed from X fps to about 25 fps or about 50 fps, wherein X fps is not about 25 fps or about 50 fps.

In order to avoid affecting viewing of users when the refresh rate of the display is updated, the third update module 434 can update the refresh rate of the display 500 to about 100 Hz during the blanking interval, whereby the users cannot perceive that the refresh rate is updated. Accordingly, the refresh rate of the display is maintained at about 100 Hz when the frame rate of the video is about 25 fps or about 50 fps. In addition, the blanking interval may be a vertical blanking interval or a horizontal blanking interval.

The detection unit 402, the first control unit 410, the second control unit 420 and the third control unit 430 are integrated in the controller. One of ordinary skill in the art will appreciate that the above examples are provided for illustrative purposes only to further explain applications of the present invention and are not meant to limit the present invention in any manner. Another device and/or software may be used as appropriate for a given application.

The first configuration module 412, the first update module 414, the second configuration module 422, the second update module 424, the third configuration module 432 and the third update module 434 may be electric circuit and/or software program.

The apparatus 400 may be executed in an image processor or a control chip, or be applied in programmed image control of the display. One of ordinary skill in the art will appreciate that the above examples are provided for illustrative purposes only to further explain applications of the present invention and are not meant to limit the present invention in any manner.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A method for processing video, comprising steps of:
(a) detecting at least one frame rate of the video; and
(b) adjusting a refresh rate of a display to about 96 Hz when the frame rate is about 24 fps.

2. The method as claimed in claim 1, wherein the step (b) comprises:
setting the refresh rate for about 96 Hz when the frame rate is changed to about 24 fps; and
updating the refresh rate to about 96 Hz during a blanking interval after the refresh rate is set.

3. The method as claimed in claim 1, further comprising:
(c) adjusting the refresh rate to about 120 Hz when the frame rate is about 30 or about 60 fps.

4. The method as claimed in claim 3, wherein the step (c) comprises:
setting the refresh rate for about 120 Hz when the frame rate is changed to about 30 or about 60 fps; and
updating the refresh rate to about 120 Hz during a blanking interval after the refresh rate is set.

5. The method as claimed in claim 1, further comprising:
(d) adjusting the refresh rate to about 100 Hz when the frame rate is about 25 or about 50 fps.

6. The method as claimed in claim 5, wherein the step (d) comprises:
setting the refresh rate for about 100 Hz when the frame rate is changed to about 25 or about 50 fps; and
updating the refresh rate to about 100 Hz during a blanking interval after the refresh rate is set.

7. An apparatus for processing video, comprising:
means for detecting at least one frame rate of the video; and
means for adjusting a refresh rate of a display to about 96 Hz when the frame rate is about 24 fps.

8. The apparatus as claimed in claim 5, wherein the means for adjusting the refresh rate of the display to about 96 Hz comprises:
means for setting the refresh rate for about 96 Hz when the frame rate is changed to about 24 fps; and
means for updating the refresh rate to about 96 Hz during a blanking interval after the refresh rate is set.

9. The apparatus as claimed in claim 7, further comprising:
means for adjusting the refresh rate to about 120 Hz when the frame rate is about 30 or about 60 fps.

10. The apparatus as claimed in claim 9, wherein the means for adjusting the refresh rate to about 120 Hz comprises:
means for setting the refresh rate for about 120 Hz when the frame rate is changed to about 30 or about 60 fps; and
means for updating the refresh rate to about 120 Hz during a blanking interval after the refresh rate is set.

11. The apparatus as claimed in claim 7, further comprising:
means for adjusting the refresh rate to about 100 Hz when the frame rate is about 25 or about 50 fps.

12. The apparatus as claimed in claim 11, wherein the means for adjusting the refresh rate to about 100 Hz comprises:
means for setting the refresh rate for about 100 Hz when the frame rate is changed to about 25 or about 50 fps; and
means for updating the refresh rate to about 100 Hz during a blanking interval after the refresh rate is set.
